(19) United States
(12) Patent Application Publication
(10) Pub. No.: US 2021/0402432 A1
(43) Pub. Date: Dec. 30, 2021

(54) METHOD AND APPARATUS TO CREATE TRANSPARENT CONDUCTIVE FILMS WITH CONTROLLED ANISOTROPIC ELECTRICAL CONDUCTIVITY

(71) Applicant: QuirkLogic, Inc., Calgary (CA)

(72) Inventor: Mahshid Sam, Victoria (CA)

(21) Appl. No.: 16/917,823

(22) Filed: Jun. 30, 2020

(51) Int. Cl. B05D 3/14

(52) U.S. Cl. CPC B05D 3/14

(57) ABSTRACT

A substrate processing system includes a liquid layer processor. The substrate processing system also includes an orchestrator. The orchestrator, after a liquid layer is deposited on a substrate: processes, using the liquid layer processor, the liquid layer to obtain a film. The film has an anisotropic conductivity. The film is disposed on the substrate. The film includes high aspect ratio conductive particles. The high aspect ratio conductive particles provide the anisotropic conductivity.

### BACKGROUND

Many materials are used to manufacture devices. Electrical devices may use combinations of dielectric, semiconducting, and conductive materials.

### SUMMARY

In one aspect, a substrate processing system in accordance with one or more embodiments of the invention includes a liquid layer processor and an orchestrator. The orchestrator may, after a liquid layer is deposited on a substrate: process, using the liquid layer processor, the liquid layer to obtain a film having an anisotropic conductivity disposed on the substrate. The film includes high aspect ratio conductive particles that provide the anisotropic conductivity.

In one aspect, a method for processing a substrate in accordance with one or more embodiments of the invention includes after a liquid layer comprising high aspect ratio conductive particles suspended in the liquid layer is deposited on the substrate: aligning a first portion of the high aspect ratio conductive particles in a first direction to obtain first aligned particles; aligning a second portion of the high aspect ratio conductive particles in a second direction to obtain second aligned particles; and obtaining a processed substrate using the first aligned particles and the second aligned particles.

In one aspect, a non-transitory computer readable medium in accordance with one or more embodiments of the invention includes computer readable program code, which when executed by a computer processor enables the computer processor to perform a method for processing a substrate. The method includes after a liquid layer comprising high aspect ratio conductive particles suspended in the liquid layer is deposited on the substrate: aligning a first portion of the high aspect ratio conductive particles in a first direction to obtain first aligned particles; aligning a second portion of the high aspect ratio conductive particles in a second direction to obtain second aligned particles; and obtaining a processed substrate using the first aligned particles and the second aligned particles.

### BRIEF DESCRIPTION OF DRAWINGS

FIG. 1 shows a diagram of a system in accordance with one or more embodiments of the invention.

FIG. 2.1. shows a side diagram of a processed substrate in accordance with one or more embodiments of the invention.

FIG. 2.2. shows a top view diagram of the processed substrate of FIG. 2.1.

FIG. 2.3 shows a top view diagram of a second processed substrate in accordance with one or more embodiments of the invention.

FIG. 2.4 shows a top view diagram of a third processed substrate in accordance with one or more embodiments of the invention.

FIG. 3.1 shows a diagram of a manufacturing system in accordance with one or more embodiments of the invention.

FIG. 3.2 shows a side view diagram of an aligner of a manufacturing system in accordance with one or more embodiments of the invention.

FIG. 3.3 shows a top view diagram of the aligner of FIG. 3.2.

FIG. 3.4 shows a side view diagram of a multilayer aligner of a manufacturing system in accordance with one or more embodiments of the invention.

FIG. 3.5 shows a top view diagram of the multilayer aligner of FIG. 3.4.

FIG. 3.6 shows a side view diagram of a motive belt aligner of a manufacturing system in accordance with one or more embodiments of the invention.

FIG. 3.7 shows a side view diagram of a motive film aligner of a manufacturing system in accordance with one or more embodiments of the invention.

FIG. 4.1 shows a diagram of a multi-aligner manufacturing system in accordance with one or more embodiments of the invention.

FIG. 4.2 shows a diagram of a multidirectional aligner manufacturing system in accordance with one or more embodiments of the invention.

FIG. 4.3 shows a diagram of a motive belt aligner manufacturing system in accordance with one or more embodiments of the invention.

FIG. 4.4 shows a diagram of a motive film aligner manufacturing system in accordance with one or more embodiments of the invention.

FIG. 4.5 shows a diagram of a transfer-based manufacturing system in accordance with one or more embodiments of the invention.

FIG. 5 shows a block diagram of a substrate processing system in accordance with one or more embodiments of the invention.

FIG. 6.1 shows a flowchart of a method of obtaining a processed substrate in accordance with one or more embodiments of the invention.

FIG. 6.2 shows a flowchart of a method of processing a liquid layer in accordance with one or more embodiments of the invention.

FIG. 6.3 shows a flowchart of a method of obtaining a superstructure in accordance with one or more embodiments of the invention.

FIG. 7 shows a diagram of a computing device in accordance with one or more embodiments of the invention.

### DETAILED DESCRIPTION

Specific embodiments will now be described with reference to the accompanying figures. In the following description, numerous details are set forth as examples of the invention. It will be understood by those skilled in the art that one or more embodiments of the present invention may be practiced without these specific details and that numerous variations or modifications may be possible without departing from the scope of the invention. Certain details known to those of ordinary skill in the art are omitted to avoid obscuring the description.

In the following description of the figures, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure.

Throughout this application, elements of figures may be labeled as A to N. As used herein, the aforementioned labeling means that the element may include any number of items and does not require that the element include the same number of elements as any other item labeled as A to N. For example, a data structure may include a first element labeled as A and a second element labeled as N. This labeling convention means that the data structure may include any number of the elements. A second data structure, also labeled as A to N, may also include any number of elements. The number of elements of the first data structure and the number of elements of the second data structure may be the same or different.

In general, embodiments of the invention relate to systems, devices, and methods for manufacturing films. A film may be a layer of one or more materials designed to perform one or more functions. Films may be used to manufacture devices including, for example, photovoltaic devices, touch screen displays, liquid crystal displays, etc.

To be used in some types of devices, films may need to have predetermined electrical, mechanical, optical, and/or other types of properties. In general, embodiments of the invention provide methods and system for manufacturing films having properties that enable them to be used in one or more devices by enabling the properties of the films to be tailored to meet the requirements of the devices.

To tailor the properties of the films to meet the requirements of different devices, a system in accordance with embodiments of the invention may enable superstructures of particles within a film to be formed. The superstructures may include, for example, chains of particles aligned in predetermined directions. The aforementioned microstructural morphology of the superstructures may impart desirable properties to the films in which the superstructures are disposed.

A system in accordance with embodiments of the invention may enable the morphologies of the superstructures within the films to be tailored. For example, the generated superstructures may include chains of particles that are aligned in predetermined manners. By aligning the particles in predetermined manners, the resulting material properties of the films may be enhanced or decreased depending on the level of alignment of the particles within the films.

For example, metal wire particles disposed within a film may be chained together to form wire chains. These chains may be preferentially aligned in one or more directions within the films. The alignment and chaining of the wires may impart anisotropic conductivity to the film that may be both tailored in (i) magnitude and (ii) degree of anisotropy. Consequently, the films produced by a system in accordance with one or more embodiments of the invention may be tailored for used in selected application.

Other properties of the films may also be tailored. For example, the type and alignment of particles within the films may be tailored to make the films transparent and/or translucent to impart desirable optical properties to the films.

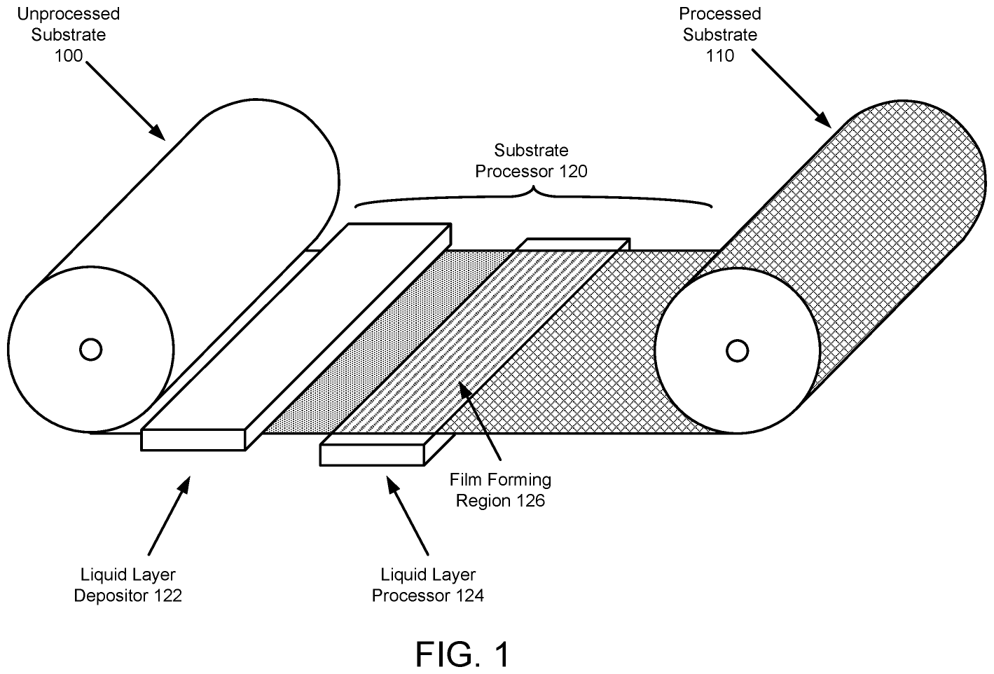

FIG. 1 shows a diagram of a system in accordance with one or more embodiments of the invention. The system of FIG. 1 may be used to process substrates (e.g., 100) to obtain films disposed on the substrates (e.g., processed substrates (e.g., 110)). In some embodiments of the invention, the films on the processed substrate are transferred to other targets (e.g., other substrates). The films may have electrical properties (and/or other properties) that may be tailored for different applications.

In one or more embodiments of the invention, the films deposited by the system of FIG. 1 provide anisotropic conductivities. In other words, the conductivity of the films provided by the system of FIG. 1 may be directionally dependent.

For example, a film provided by the system of FIG. 1 may have (i) a conductivity of 1 Siemen per meter (S/m) along a length of the film (e.g., from left to right in FIG. 1) and (ii) a conductivity of 0.5 S/m along a width of the film (e.g., into and out of the page in FIG. 1). The system of FIG. 1 may be used to produce films that have any degree (e.g., variance in any number of directions) of anisotropy (or lack, thereof, of anisotropy) without departing from the invention. The films may also present any number and/or type of properties (e.g., electrical such as permittivity and/or permeability, mechanical such as elasticity and/or stiffness, thermal, optical, etc.) that are anisotropic (and/or isotropic).

The properties of the films provided by the system of FIG. 1 may be tailored for use in one or more applications. For example, the magnitude of the conductivity and/or anisotropy of the of the films may be tailored to meet predetermined goals by modifying the process used to manufacture the films. By doing so, films may be manufactured in a manner to facilitate electrical applications such as use of the films in photovoltaic, touch screen, and/or other types of applications.

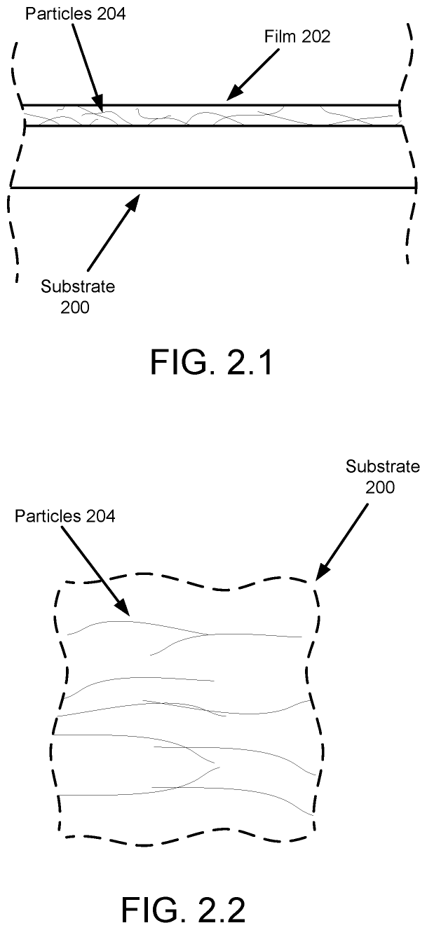

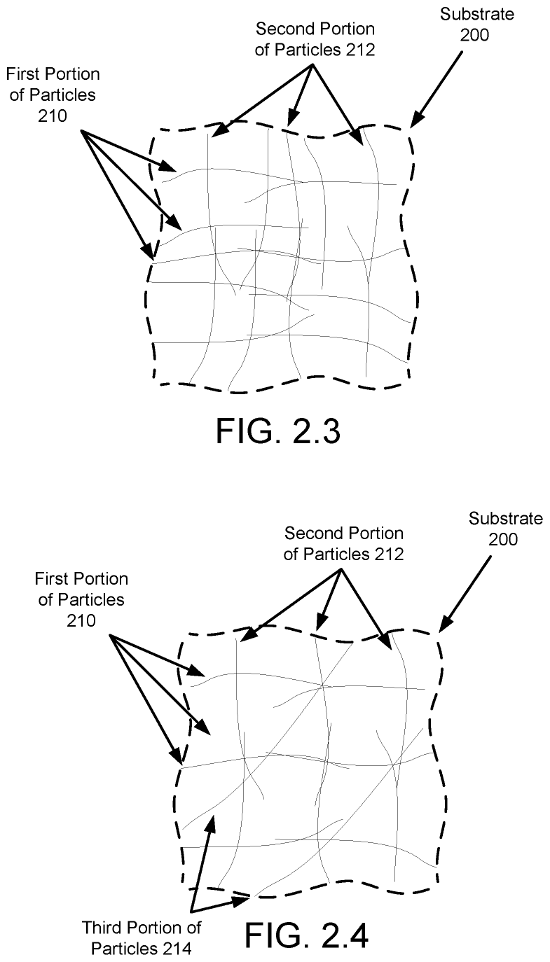

In one or more embodiments of the invention, the films deposited by the system of FIG. 1 are transparent or translucent. In other words, at least a portion of light that is incident (at least at normal incidence) on a surface of the film is able to transmit through the film to the substrate (or another structure shadowed by the film) at least partially shadowed by the film. For additional details regarding films that may be produced by the system of FIG. 1, refer to FIGS. 2.1-2.4.

To process substrates, the system of FIG. 1 may employ a roll-to-roll processing paradigm. For example, a roll of an unprocessed substrate (100) may be processed by a substrate processor (120) to obtain a processed substrate (110). The processed substrate (110) may include a film when compared to the unprocessed substrate (100). The added film may have a conductivity (e.g., anisotropic or isotropic) and/or other properties (e.g., transparency/translucency) tailored for use in one or more applications.

To processes the substrate, the substrate processor (120) may deposit a film on the substrate. As noted above, the film may provide characteristics tailed to an application for the processed substrate (110). For example, if the processed substrate (110) is to be used in photovoltaic applications, the transparency and conductivity of the film may be tailored to ensure that the transparency of the film is sufficiently high while also providing sufficient conductivity to enable electricity generated by the photovoltaic device to be collected.

In one or more embodiments of the invention, the substrate processor (120) includes, at least, a liquid layer depositor (122) and a liquid layer processor (124). The substrate processor (120) may include additional components without departing from the invention.

The aforementioned components of the substrate processor (120) may cooperate to produce films having desirable properties. The films may be deposited on unprocessed substrates (100) to obtain the processed substrate (110).

The liquid layer depositor (122) may be one or more physical devices. The liquid layer depositor (122) may form a layer of liquid deposited on the unprocessed substrate (100). The liquid layer may extend across all or a portion of the width of the unprocessed substrate (100) (e.g., into the page in FIG. 1). For example, the liquid layer depositor (122) may selectively deposit the liquid layer on the unprocessed substrate (100).

In one or more embodiments of the invention, the unprocessed substrate (100) is a roll of substrate. The roll may be disposed on a drum, roller, or other structure that enables the roll to be unrolled. The processed substrate (110) may be collected by a similar structure (e.g., a drum) forming a roll of the processed substrate (110). Consequently, when the unprocessed substrate (100) is unrolled, the unprocessed substrate (100) may pass by the substrate processor (120).

The liquid layer depositor (122) may form a liquid layer on the unprocessed substrate (100) using any method without departing from the invention. For example, the liquid layer depositor (122) may be implemented using a sprayer that sprays a liquid onto a surface of the unprocessed substrate (100). In another example, the liquid layer depositor (122) may be implemented as an ultrasonic mist generator that causes the mist to be deposited on a surface of the unprocessed substrate (100) thereby forming a liquid layer disposed on the unprocessed substrate (100).

In one or more embodiments of the invention, the liquid layer deposited by the liquid layer depositor (122) includes, at least, (i) a liquid and (ii) particles. These components of the liquid layer may be manipulated by the liquid layer processor (124) to form a film and/or a precursor to a film.

The liquid of the liquid layer may include at least one component that may be volatilized or otherwise removed to form the film. For example, all, or portion, of the liquid of the liquid layer may be removed to form a solid film. The solid film may include particles and/or other components.

The particles of the liquid layer may be manipulated by the liquid layer processor (124) to form the superstructure of the particles that has desirable characteristics. For example, the superstructure formed using the particles may have (i) desirable levels of conductivity, (ii) desirable levels of anisotropy in the conductivity, and/or (iii) desirable levels of translucency. The aforementioned properties of the superstructure may be tailored to meet the requirements of a target application for the film and/or processed substrate (110).

In one or more embodiments of the invention, the particles of the liquid layer include high aspect ratio particles. For example, the high aspect ratio particles may have an aspect ratio of greater than 10 to 1 (e.g., length to width/diameter), an aspect ration of greater than 100 to 1, and/or an aspect ratio of greater than 1000 to 1.

In one or more embodiments of the invention, the particles may include multiple types of high aspect ratio particles. For example, the particles may include a first portion of particles having an aspect ratio of greater than 10 to 1, a second portion of particles having an aspect ratio of greater than 100 to 1, etc.

In one or more embodiments of the invention, at least a portion of the particles have a high conductivity. The high conductivity may be a conductivity that is greater than 1 million Siemens per meter.

In one or more embodiments of the invention, at least a portion of the particles are metallic. Metallic particles may include metal content of at least 90%.

In one or more embodiments of the invention, at least a portion of the particles are carbon-based particles. Carbon based particles may include carbon content of at least 90%.

In one or more embodiments of the invention, at least a portion of the particles are not high aspect ratio particles. For example, the particles may include a portion of approximately spherical particles.

In one or more embodiments of the invention, at least a portion of the particles are nanoparticles. For example, the particles may include nano wires formed from metal and/or carbon.

The liquid layer deposited by the liquid layer depositor (122) may include additional components without departing from the invention. For example, the liquid layer may include a binder. The binder may lock the particles into a superstructure after the superstructure is formed. For example, the binder may be a polymeric material that forms a solid polymer film which encapsulates all, or a portion, of the superstructure formed by the particles.

In another example, the liquid layer may include a superstructure modifier component. The superstructure modifier component may modify a morphology of the superstructure after the superstructure is formed. The superstructure modifier component may, for example, reinforce (e.g., mechanically, electrically, etc.) joints between particles of the superstructure. The superstructure modifier component may be a source of free metallic ions that preferentially deposit themselves at the joints between the particles of the superstructure. For example, the superstructure modifier may be silver-neodecanoate or other type of metal ion source (e.g., organometallic compounds, metal salts, metal halides, etc.) that may be activated (e.g., exposure to heat, light, etc.) to release metal ions, particles, and/or other materials that may modify the joints and/or other features of a superstructure.

In one or more embodiments of the invention, the liquid layer processor (124) processes the liquid layer formed by the liquid layer depositor (122). The liquid layer processor (124) may process the liquid layer by manipulating one or more components of the liquid layer. For example, a liquid layer processor (124) may modify the location and/or orientation of one or more particles disposed in the liquid layer. By doing so, a superstructure may be formed from the particles. For additional details regarding superstructures formed using the liquid layer processor (124), refer to FIGS. 2.1-2.4.

In one or more embodiments of the invention, the liquid layer processor (124) processes the liquid layer by applying electromagnetic fields to the liquid layer. Electromagnetic fields applied to the liquid layer may interact with the particles disposed in the liquid layer. The interaction between electromagnetic fields and the particles may cause the particles to change their locations and/or orientations within the liquid layer.

For example, the particles in the liquid layer may form chains of particles. The chains of particles may be oriented in accordance with electromagnetic fields applied by the liquid layer processor (124). Thus, by selectively applying electromagnetic fields to the liquid layer, superstructures having desirable structures may be formed from the particles included in the liquid layer.

When the liquid layer processor (124) applies the electromagnetic field, the liquid layer disposed within a film forming region (126) may interact with the applied electromagnetic field. The aforementioned interaction may cause the particles within the film forming region (126) to form the superstructure having a structure that corresponds to the applied electromagnetic fields.

For example, dielectrophoretic forces (including dipole-dipole interactions) applied to the particles by the electromagnetic field may cause the particles to form a superstructure. The superstructure may include chains of particles that extend through the liquid layer. The chains of particles may be oriented with respect to one or more directions while no chains may be oriented with respect to other directions. Consequently, the materials properties of the liquid layer and resulting film may be preferentially enhanced and/or minimized depending on the orientations of the particle chains.

In one or more embodiments of the invention, the system of FIG. 1 operates by unrolling a portion of the unprocessed substrate (100). The portion of the unprocessed substrate (100) may then be fed to the liquid layer depositor (122). The liquid layer depositor (122) may deposit the liquid layer onto a surface of the portion of the unprocessed substrate (100). The portion of the unprocessed substrate (100) may then be moved to the film forming region (126). While in the film forming region (126), a liquid layer processor (124) may apply a predetermined electromagnetic field pattern to the liquid layer in the film forming region (126). To do so, for example, power may be supplied to the liquid layer processor (124), the liquid layer processor (124) may be moved with respect to the liquid layer (e.g., closer or further away to modulate the level of field interaction), and/or electromagnetic fields may be applied to the liquid layer in other manners. Application of the electric field may cause the particles of the liquid layer to form a desired superstructure. Once the superstructure is formed, the portion of unprocessed substrate (100) may include the desired superstructure thereby forming a processed substrate (110) that includes a film having desirable characteristics imparted by the superstructure included in the film. The processed substrate (110) may be rolled up into a roll or otherwise collected for future use.

To roll and unroll the substrate, drums operably connected to motors, may be utilized. Other structures may be used to facilitate rolling and unrolling of substrates without departing from the invention.

While the system of FIG. 1 has been illustrated as including a limited number of specific components, a substrate processing system in accordance with embodiments of the invention may include fewer, additional, and/or different components without departing from the invention.

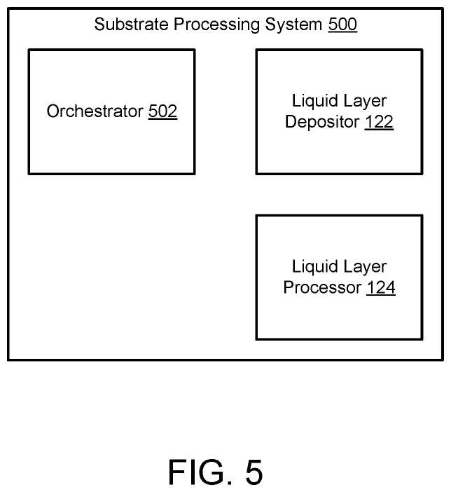

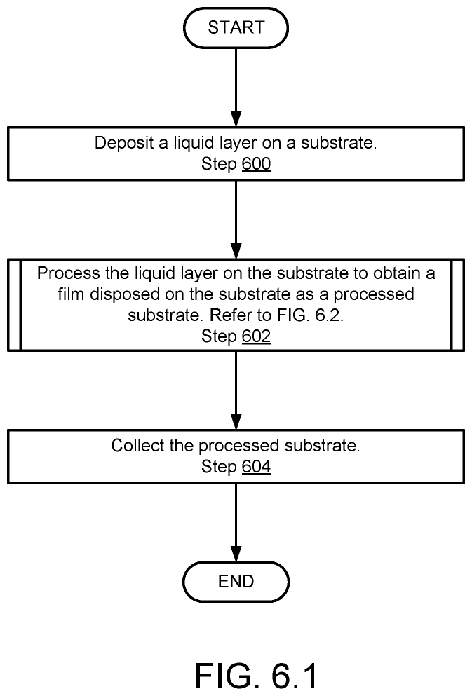

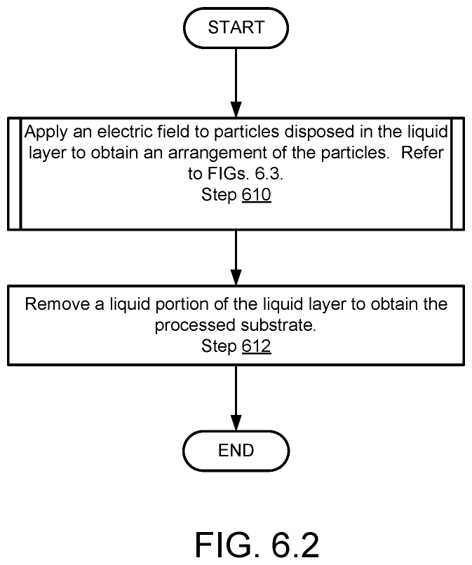

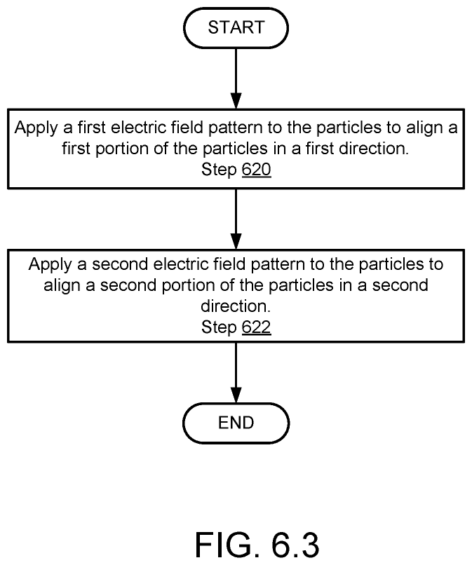

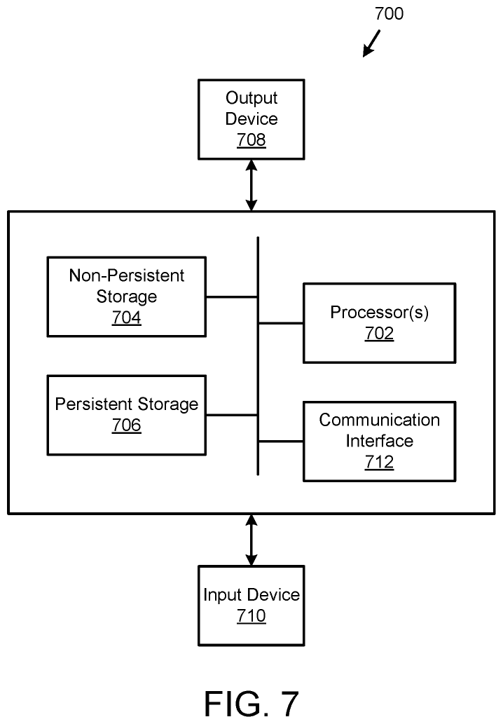

For example, the system of FIG. 1 may operate using one or more computing devices. For a description of a computing device, refer to FIG. 7. Refer to FIG. 5 for a description of a block level view of the system of FIG. 1. Refer to FIGS. 6.1-6.3 for a description of methods that may be performed using and/or by the system of FIG. 1 when the system of FIG. 1 provides its functionality.

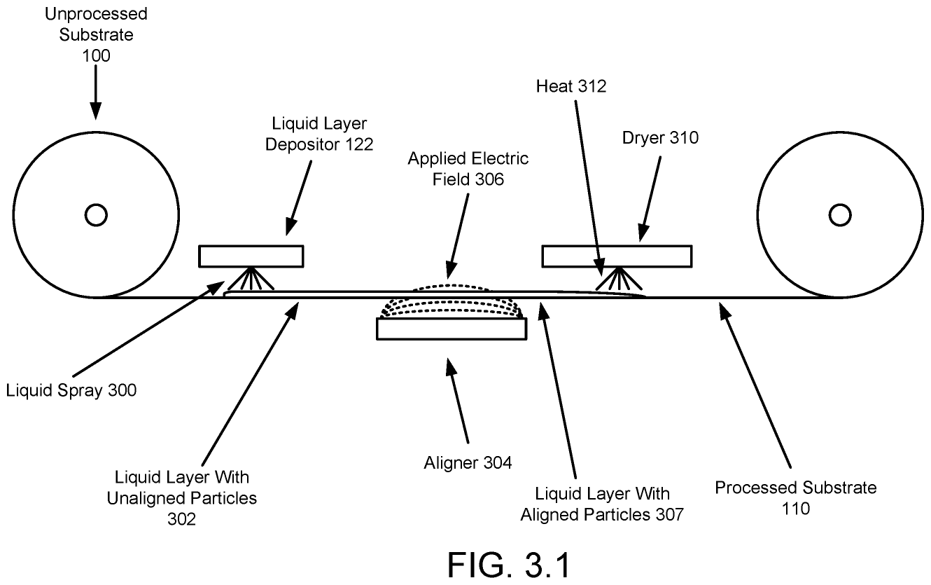

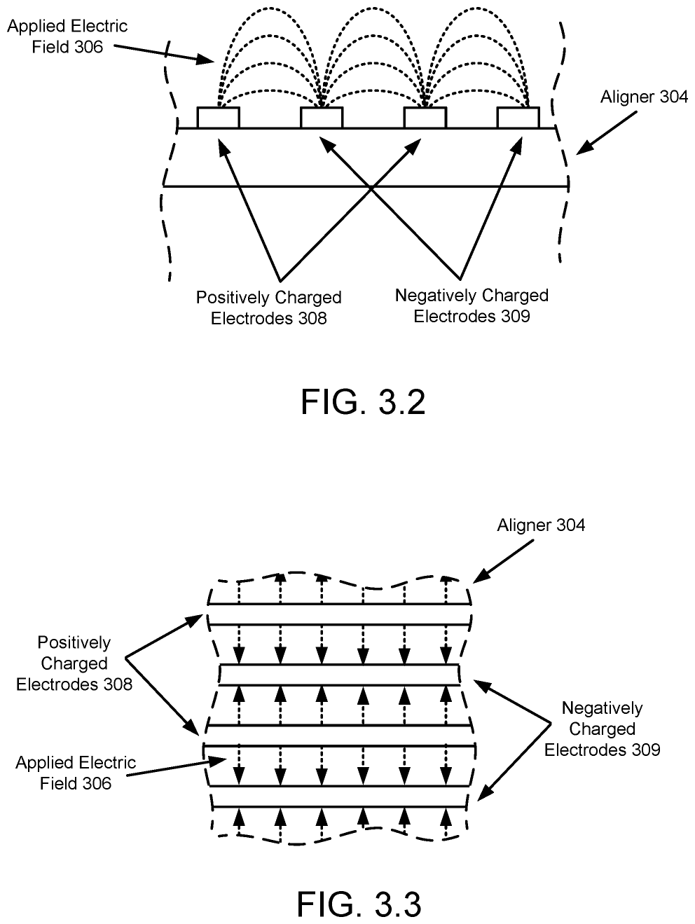

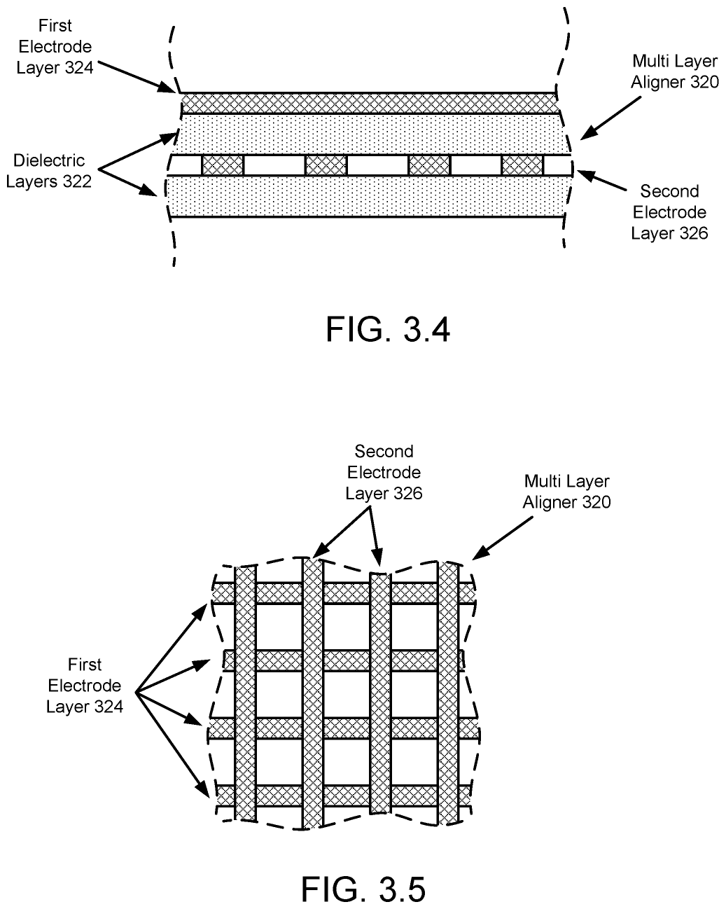

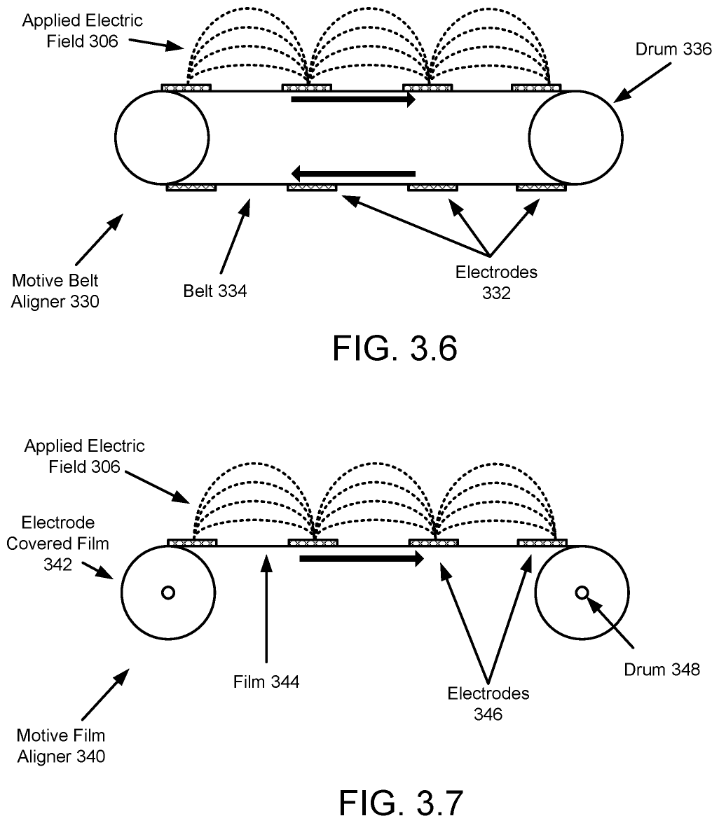

Additionally, the system of FIG. 1 may include components (not shown in FIG. 1) that may enable a broader range of substrates to be processed and/or for substrates to be processed in a more complex manner. Refer to FIGS. 3.1-4.5 for additional descriptions of components that may be included in the system of FIG. 1.

As discussed above, the system of FIG. 1 may be used to obtain processed substrates. The processed substrates include films having desirable properties. FIGS. 2.1-2.4 show diagrams of examples of processed substrates including films in accordance with one or more embodiments of the invention.

FIG. 2.1 shows a side view diagram of a processed substrate in accordance with one or more embodiments of the invention. In FIG. 2.1, wavy, vertically oriented, dashed lines along the left and right hand side of the diagram are used to indicate that the processed substrate continues to the left and right of the diagram. In the figures (e.g., 2.2, 2.3, 2.4, 3.2, 3.3, 3.4, 3.5) that follow, similar wavy, dashed lines are used to indicate that the structures included in the figures continue in extent outside of the area depicted within the wavy, dashed lines along one or more edges of the diagrams.

Returning to the discussion of FIG. 2.1, the processed substrate includes a substrate (200) upon which a film (202) is disposed. The substrate (200) may be formed from one or more materials upon which the film (202) may be disposed. For example, the substrate (200) may be a polymer film. In another example, the substrate may be a glass sheet. In a still further example, the substrate (200) may be a semiconductor material. The substrate (200) may be formed from other types of materials without departing from the invention.

The film (202) may be a physical structure disposed on the substrate (200). The film (202) may include particles (204). As noted above, the particles (204) may be positioned and/or oriented within the film (202) to form a superstructure. The superstructure may have any type of microstructure that results in the superstructure providing desirable properties such as, for example, anisotropic conductivity. For additional details regarding superstructures that may provide anisotropic conductivities, refer to FIGS. 2.2-2.4.

The particles (204) may be formed using any type of material. For example, the particles (204) may be formed from carbon (e.g., carbon nanotubes, carbon nanosheets, spherical carbon particles, etc.), metals (e.g., copper, silver, gold, alloy, or other types of metallic particles), or any other types of materials that may provide desirable levels of conductivity.

In one or more embodiments of the invention, the particles (204) performed using multiple types of material. For example, the particles (204) may be metallic rods coated in a material that enables the particles (204) to form joints between the particles (204) when the particles (204) are arranged in a superstructure (e.g., chains aligned predetermined directions).

In one or more embodiments of the invention, the particles (204) are a heterogeneous collection of multiple types of particles. For example, the particles (204) may include wire particles (e.g., high aspect ratio particles of length to width (L/W) of 100 to 1 or more), rod particles (e.g., aspect ratio particles of L/W of 2 to 1 or more), and/or spherical particles (e.g., aspect ratio particles of L/W of ˜1 to 1). The particles (204) may include additional types of particles without departing from the invention.

In one or more embodiments of the invention, the film (202) includes a binder. The binder may, for example, maintain the relative locations and orientations of the particles with respect to one another. The binder may also, for example, maintain relative locations and orientations of the particles with respect to the substrate (200). For example, the film (202) may include a polymer material that adheres to the substrate (200) and/or encapsulates the particles (204).

Returning to FIG. 2.2, FIG. 2.2 shows a top view diagram (e.g., looking downward from the top of FIG. 2.1) of the substrate (200). As noted above, the wavy, dashed lines indicate that FIG. 2.2 shows a portion of the surface of the processed substrate which extends in all directions from that illustrated in FIG. 2.2.

As seen in FIG. 2.2, the particles (204) are illustrated as being high aspect ratio particles (e.g., wire like particles). Additionally, the particles (204) have been formed into a superstructure by (i) chaining multiple particles together and (ii) aligning the particles (204) from left to right in the diagram.

To form this superstructure, the particles (204) may have been exposed to an electromagnetic field directed from left to right in the diagram (e.g., electric field aligned from left to right). Refer to FIGS. 3.2-3.3 for details regarding how to apply an electromagnetic field having the aforementioned orientation.

By forming the particles (204) into the aforementioned superstructure, the particles (204) may impart properties to the processed substrate. Specifically, the particles (204) may impart in anisotropic conductivity to the processed substrate. For example, the particles (204) may form conduction paths that are aligned from left to right in the diagram. In contrast, conduction paths from the top to the bottom of the diagram may not be present. Consequently, the conductivity of the processed substrate from left to right in the diagram is much larger than the conductivity of the processed substrate from top to bottom in the diagram. Thus, the particles (204) have imparted an anisotropic conductivity to the processed substrate.

Additionally, the particles (204) may impart other desirable properties to the processed substrate. For example, the thermal conduction of the processed substrate from left to right may be much larger than the thermal conductivity from top to bottom. Further, the optical properties of the processed substrate may now be orientation dependent by virtue of the alignment of the particles (204).

The magnitude of the properties imparted to the processed substrate by the particles (204) may be tailored by (i) modifying the degree of alignment of the particles (204) and (ii) modifying the quantity of the particles (204). Thus, the processed substrates produced via the method and system illustrated with respect to FIG. 1 may provide properties desirable for a wide range of applications.

To control the degree of alignment of the particles, the system of FIG. 1 may selectively apply electromagnetic fields that cause different portions of the particles (204) to preferentially align in different directions.

Turning to FIG. 2.3, FIG. 2.3 shows a second top view diagram of the substrate (200). In FIG. 2.3, the particles have been exposed to a more complicated electromagnetic field structure. Specifically, the particles have been exposed to electromagnetic fields that are aligned from left to right in the diagram and from top to bottom in the diagram. Consequently, a first portion of the particles (210) have aligned from left to right in the diagram and a second portion of the particles (212) have aligned from top to bottom in the diagram. Additionally, both portions of the particles have formed chains.

For example, as seen from FIG. 2.3, the first portion of the particles (210) have chained together thereby resulting in a pattern similar to that seen in FIG. 2.2. In contrast, the second portion of the particles (212) have chained together, similar to the chains formed by the first portion of the particles (210), in an alignment directed from the top to the bottom of the page (e.g., approximately rotated 90° with respect to the chains of the first portion of the particles (210)).

By forming the superstructure illustrated in FIG. 2.3, the superstructure imparts a first conductivity, from left to right in the diagram, to the processed substrate. Similarly, the superstructure imparts a second conductivity, from top to bottom in the diagram, to the processed substrate. The ratio between the first conductivity and the second conductivity may be controlled by, for example, modulating the relative strength of the electromagnetic field applied to the particles with respect to these different directions. The magnitudes of the first conductivity and the second conductivity may be controlled by the number of particles included in the film.

Returning to FIG. 2.4, FIG. 2.4 shows a third top view diagram of the substrate (200). In FIG. 2.4, the particles have been exposed to an electromagnetic field structure having components directed in three directions. The electromagnetic field structure included a first component aligned from left to right in the diagram, a second component aligned from top to bottom in the diagram, and a third component aligned from bottom left to top right in the diagram. Consequently, a first portion of the particles (210) is aligned from left to right in the diagram, a second portion of the particles (212) is aligned from top to bottom in the diagram, and a third portion of the particles (214) is aligned from bottom left to top right in the diagram. Like the particles discussed with respect to FIG. 2.3, each of these portions of formed corresponding chains of particles.

By forming the superstructure illustrated in FIG. 2.4, the superstructure imparts a first conductivity, from left to right in the diagram, to the processed substrate. Similarly, the superstructure imparts a second conductivity, from top to bottom in the diagram, to the processed substrate. The superstructures also impart a third conductivity, from bottom left to top right in the diagram, to the processed substrate. As noted with respect to the discussion of FIG. 2.3, the relative ratio and magnitude of these conductivities can be tailored by modifying the relative strength of the electromagnetic field aligned with each of these directions and the quantity of particles included in the film.

While films having particles formed into chains aligned with one, two, and three directions have been illustrated with respect to FIGS. 2.2-2.4, a processed substrate in accordance with embodiments of the invention may include particles formed into superstructures aligned in any number of directions without departing from the invention by applying electromagnetic field patterns having alignment in the aforementioned directions.

Additionally, while illustrated as being aligned in directions confined to a plane, processed substrates may include particles aligned out of planar directions without departing from the invention. For example, processed substrates may include substrates having particles aligned in three cartesian directions without departing from the invention.

To form processed substrates, diagrams of systems and methods that may be used to form processed substrates are illustrated in FIGS. 3.1-4.5.

Turning to FIG. 3.1, FIG. 3.1 shows a diagram of a processed substrate forming system in accordance with one or more embodiments of the invention. The processed substrate forming system illustrated in FIG. 3.1 may employ a roll to roll processing paradigm where unprocessed substrate (100) is unrolled, processed to obtain processed substrate (110), and rolled to form a roll of processed substrate (110).

To process the unprocessed substrate (100), the system may include a liquid layer depositor (122), and an aligner (304), and a dryer (310). The operation of the aforementioned components as discussed below.

The liquid layer depositor (122) may be one or more physical devices that forms a liquid layer on the unprocessed substrate (100). For example, the liquid layer depositor (122) may eject a liquid spray (300). The liquid spray (300) may form a liquid layer with unaligned particles (302) on the unprocessed substrate (100).

For example, the liquid layer depositor (122) may be implemented using one or more spray nozzles, sonicators, or other devices usable to deposit a liquid layer on the unprocessed substrate (100). The liquid layer depositor (122) may be coupled to a source of liquid that includes the unaligned particles. The liquid layer depositor (122) may draw liquid from the source to form the liquid spray (300).

The liquid layer depositor (122) may selectively form the liquid layer on the unprocessed substrate (100). For example, the liquid layer may only extend partially across the width of the unprocessed substrate.

In another example, the liquid layer may be masked from certain portions of the unprocessed substrate (100) along the length of the substrate. The liquid layer depositor (122) may mask portions of the unprocessed substrate (100) by selectively suspending all, or portion, of the liquid spray (300) as the unprocessed substrate traverses near the liquid layer depositor (122).

In a still further example, the liquid layer depositor (122) may selectively form different thicknesses of liquid layers on the unprocessed substrate (100). The liquid layer depositor (122) may form different thicknesses of liquid layers on the unprocessed substrate (100) by selectively increasing or decreasing the rate of the liquid spray (300) is the unprocessed substrate traverses near the liquid layer depositor (122).

In yet another example, the liquid layer depositor (122) may selectively modify the concentration of unaligned particles (302) in different portions of the liquid layer on the unprocessed substrate (100). The liquid layer depositor (122) may form different portions of the liquid layer with different concentrations of unaligned particles (302) by injecting different numbers of particles and liquid spray (300) as the unprocessed substrate traverses near the liquid layer depositor (122). The liquid layer depositor (122) may modify the amount of other components of the liquid layer (e.g., binder concentration) using similar methods.

After the liquid layer depositor (122) forms the liquid layer with unaligned particles (302), the aligner (304) may align the unaligned particles within the liquid layer to form a liquid layer with aligned particles (307). The aligner (304) may be a physical device is to form superstructures of particles included in a liquid layer. For example, the aligner (304) may apply an electric field (e.g., 306) to the particles in the liquid layer. The applied field may cause the particles to reposition and/or reorient themselves with respect to one another to form a desired superstructure. The desired superstructure may include, at least in part, aligned particles that impart desired properties to the processed substrate (110). For additional details regarding the aligner (304), refer to FIGS. 3.2-3.7.

After liquid layer with aligned particles (307) is formed, the liquid layer may be processed by a dryer (310) to form the processed substrate (110). The dryer (310) may be a physical device that removes one or more components from the liquid layer to form a film. For example, the dryer (310) may remove one or more liquid components from the liquid layer. By doing so, the remaining components of the liquid layer may be consolidated into a film.

For example, the liquid layer may include a liquid component, a binder, and aligned particles. Removing the liquid component may cause the binder to lock the line particles into place with respect to one another and/or the substrate upon which the film is disposed. In some embodiments of the invention, removal of the liquid component may cause a chemical reaction to occur (e.g., polymerization) that causes the binder to lock the aligned particles in place as well as impart chemical resistance, mechanical strength, and/or other desirable properties to the processed substrate (110).

To remove the liquid component, the dryer (310) may apply heat (312) to the liquid layer. The applied heat (312) may cause the liquid component to be removed from the liquid layer by evaporating the liquid component. The dryer (310) may remove one or more liquid components using other methods (e.g., reducing the atmosphere, applying light or other stimuli, etc.) without departing from the invention.

After forming the processed substrate, the processed substrate may be rolled for future use, used for additional processing, be subjected to other steps in a multistep manufacturing process, etc.

As discussed above, an aligner (304) may be used to form a superstructure from particles disposed within a liquid layer. FIGS. 3.2-3.7 show diagrams of aligners in accordance with one or more embodiments of the invention.

FIG. 3.2 shows a side view diagram of a portion of an aligner (304) in accordance with one or more embodiments of the invention. As noted above, the aligner may be used form superstructures from particles.

The form superstructures from particles, the aligner may generate an applied electric field (306). In FIG. 3.2, a field pattern of the applied electric field (306) is illustrated using short dashed lines.

To generate the applied electric field (306), the aligner (304) may include electrodes (e.g., 308, 309). The electrodes may be electrically conductive structures that may be charged using electricity. When charged, the applied electric field (306) may emanate from the electrodes. The resulting structure of the applied electric field (306) may depend on the structure and charging of the electrodes.

The electrodes may include positively charged electrodes (308) and negatively charged electrodes (309). By charging the electrodes, the applied electric field (306) may be generated by virtue of the separation in charge between the differently charged electrodes.

In one or more embodiments of the invention, the electrodes are disposed on a structural element to maintain the relative basement and orientation of the electrodes with respect to one another. In one or more embodiments of the invention, at least a portion of the electrodes are interdigitated electrodes. The interdigitated electrodes may be oppositely charged thereby causing electromagnetic field to be established between the interdigitated electrodes. As will be discussed in greater detail below, multiple sets of interdigitated electrodes may be utilized to apply more complex electromagnetic field patterns to particles disposed in a liquid layer.

As seen from FIG. 3.2, the applied electric field (306) generated by the aligner (304) may have a limited range. For example, as the distance away from the electrodes increases, the strength of the applied electric field (306) may decrease and make continued. Consequently, application of the applied electric field (306) to the particles disposed in a liquid layer may be modulated by moving the aligner (304) and/or the liquid layer with respect to one another. Similarly, application of the applied electric field (306) to the particles disposed in the liquid layer may be modulated by changing the amount of electric power to generate the applied electric field (306) and/or entirely discontinuing generation of the applied electric field (306) by cutting off electric power used to charge the electrodes.

Turning to FIG. 3.3, FIG. 3.3 shows a top view diagram of the aligner (304) of FIG. 3.2. In other words, a view of the electrodes of the aligner (304). Like FIG. 3.2, applied electric field (306) is illustrated in FIG. 3.3 using short dotted lines. However, arrows have been added to the short dotted lines to indicate the relative eminence and termination of the applied electric field (306). In other words, the applied electric field (306) may emanate from positively charged electrodes (308) and terminate on negatively charged electrodes (309).

As seen from FIG. 3.3, the applied electric field (306) generated by the aligner (304) has a field pattern that is aligned top to bottom in the diagram. Consequently, if the aligner (304) is used to align particles may liquid layer, the particles would form chains aligned from top to bottom of the diagram of FIG. 3.3. Accordingly, the aligner (304) of FIG. 3.3 may be used to generate superstructure similar to that illustrated in FIG. 2.2 but aligned from top to bottom in the diagram rather than from left to right.

To generate more complicated superstructures, a multilayer aligner may be utilized. FIG. 3.4 shows a side view diagram of a multilayer aligner (320) in accordance with one or more embodiments of the invention. The multilayer aligner (320) may be used to generate the superstructure that includes chains of particles aligned in more than one direction.

The multilayer aligner (320) may include multiple layers of electrodes (324, 326). Each of the layers may include a set of interdigitated electrodes adapted to generate an electric field aligned with a corresponding directly. The respective layers of the electrodes may be aligned with different directions thereby enables chains aligned with different directions to be generated. Each of the electrode layers may be separated from the other layers of electrodes by dielectric layers (322).

To generate the electric fields, the interdigitated electrodes of each of the electrode layers may be positively and negatively charged to generate corresponding electromagnetic field patterns. The resulting electromagnetic field patterns may cause different portions of particles in a liquid layer to chain and align with the corresponding directions associated with electrode layers.

For example, in FIG. 3.4, the first electrode layer (324) is aligned to generate an electric field that extends into and out of the page. In contrast, the second electrode layer (326) is aligned to generate an electric field that extends the left to right in the diagram. These separate electric field patterns may cause different portions of particles disposed within a liquid layer to preferentially chain and align with these different directions. Accordingly, the superstructure similar to that illustrated in FIG. 2.3 may be generated using the multilayer aligner (320) of FIG. 3.4. To generate the superstructure of FIG. 2.4, a multilayer aligner that includes three layers of electrodes may be utilized.

A multilayer aligner in accordance with embodiments of the invention may include any number of layers of electrodes that correspond to any number of directions without departing from the invention.

To apply an electric field using the multilayer aligner (320), the electrodes of each electrode layer may be charged separately and/or concurrently. If charged separately, each of the electrode layers may be charged for corresponding periods of time to cause the generated applied electric fields to interact with the particles disposed in the liquid layer. If charged concurrently, a liquid layer may only need to be exposed to the applied electric field for one predetermined amount of time.

To modify the resulting properties of the superstructure, the strengths of the applied electric fields generated by each of the electrode layers may be modulated. By doing so, different quantities of particles may be preferentially aligned and chained based on the relative weighting of the strengths of the applied electric fields. Accordingly, the resulting properties of the superstructure generated by application of the applied electric fields may be modulated accordingly.

Turning to FIG. 3.5, FIG. 3.5 shows a top view diagram of the multilayer aligner (320) of FIG. 3.4. As seen in FIG. 3.5, the first electrode layer (324) and the second electrode layer (326) may be formed as interdigitated electrodes aligned to corresponding directions. Any number of electrode layers may be stacked with respect to each other.

In FIGS. 3.1-3.5, the aligners have been illustrated as being generally static structures during application of electric fields to particles disposed in liquid layers. Accordingly, to use the aforementioned structures, the portions of the unprocessed substrate upon which the liquid layers are disposed may need to be temporarily stopped proximate to the aligners.

For example, the electric field may need to be applied to corresponding portions of the liquid layer for predetermined amounts of time for the superstructures corresponding to the different portions of the liquid layer to be formed. If the liquid layer were to continue to move with respect to the applied electric field, the applied electric field may not position and/or orient the particles disposed within the liquid layer in a desirable manner (except for situations in which the direction of travel of the liquid layer due to movement of a substrate does not result in variation of the applied electric field generated by the aligner, in other words, where the applied electric field does not vary in the direction of travel).

For example, consider a scenario where an aligner applies an electric field directed perpendicularly to the direction of travel but that does not vary in the direction of travel. Such a field may be applied by an aligner having interdigitated electrodes that are aligned in the direction of travel. In such an environment, as particles traverse along in the direction of travel, the electric field (magnitude, direction, and pattern) applied to the particles may not change due to movement of the particles.

However, now consider a scenario in which an aligner applies an electric field pattern that spatially varies in the direction of travel. Such a field may be applied by an aligner having interdigitated electrodes that are aligned perpendicularly to the direction of travel. In such an environment, as particles traverse along in the direction of travel, the electric field (magnitude, direction, and pattern) applied to the particles may change as the particles move along the direction of travel. This scenario may limit the ability of the particles to be aligned while they travel through an applied electric field.

In one or more embodiments of the invention, a motive aligner may be used when it may be desired to continuously move a substrate as part of a substrate processing system. A motive aligner may be a physical device that applies an electric field that moves along with a liquid layer as it traverses a substrate processing system. FIGS. 3.6-3.7 show diagrams of motive aligners in accordance with embodiments of the invention.

FIG. 3.6 shows a diagram of a motive belt aligner (330) in accordance with one or more embodiments of the invention. The motive belt aligner (330) may generate an applied electric field (306) that moves. The rate and direction of movement of the applied electric field (306) may be matched to that of a liquid layer as a liquid layer traverses a substrate processing system.

To generate the moving applied electric field (306), the motive belt aligner (330) may include electrodes (332) disposed on a belt (334). The belt (334) may be disposed on one or more drums (336) that causes the belt to traverse a closed path indicated by the large, solid arrows.

As the belt traverses the closed path, the electrodes (332), disposed on the belt (334) may be charged thereby generating an applied electric field (306) that moves. The rate at which the belt traverses the closed path may be modulated to match the rate of movement of the applied electric field (306) to that of a liquid layer to which the applied electric field (306) is to be applied. Consequently, corresponding regions of the liquid layer may be continuously exposed to the same applied electric field (306) as the liquid layer traverses a substrate processing system.

Turning to FIG. 3.7, FIG. 3.7 shows a diagram of a motive film aligner (340) in accordance with one or more embodiments of the invention. The motive film aligner (340) may generate an applied electric field (306) that moves. The rate and direction of movement of the applied electric field (306) may be matched to that of a liquid layer is a liquid layer traverses a substrate processing system.

To generate the moving applied electric field (306), the motive film aligner (340) may include an electrode covered film (342). The electrode covered film (342) may include a film (344) on which electrodes (346) are disposed. The electrodes (346) may be charged to generate the applied electric field (306).

The electrode covered film (342) may be disposed on drums (e.g. 348) that cause the electrode covered film (342) to be unrolled and moved along a path indicated by the large solid arrow. By unrolling and rolling the electrode covered film (342) at a predetermined rate, the rate at which the unrolled portion of the electrode covered film (342) moves may be matched to that of a corresponding portion of the liquid layer as the liquid layer traverses a substrate processing system. Consequently, the corresponding applied electric field (306) generated by the electrode covered film (342) may be moved in a manner corresponding to the movement of the liquid layer. Accordingly, the liquid layer may be continuously exposed to the same applied electric field (306) as the liquid layer traverses the substrate processing system.

Thus, the motive aligners illustrated in FIGS. 3.6-3.7 may be utilized to continuously apply the same electric field to corresponding portions of liquid layers as the liquid layer traverse substrate processing systems. Consequently, rolls of unprocessed substrates may be continuously processed without needing to stop the processing to match the location of applied electric fields to corresponding portions of liquid layers.

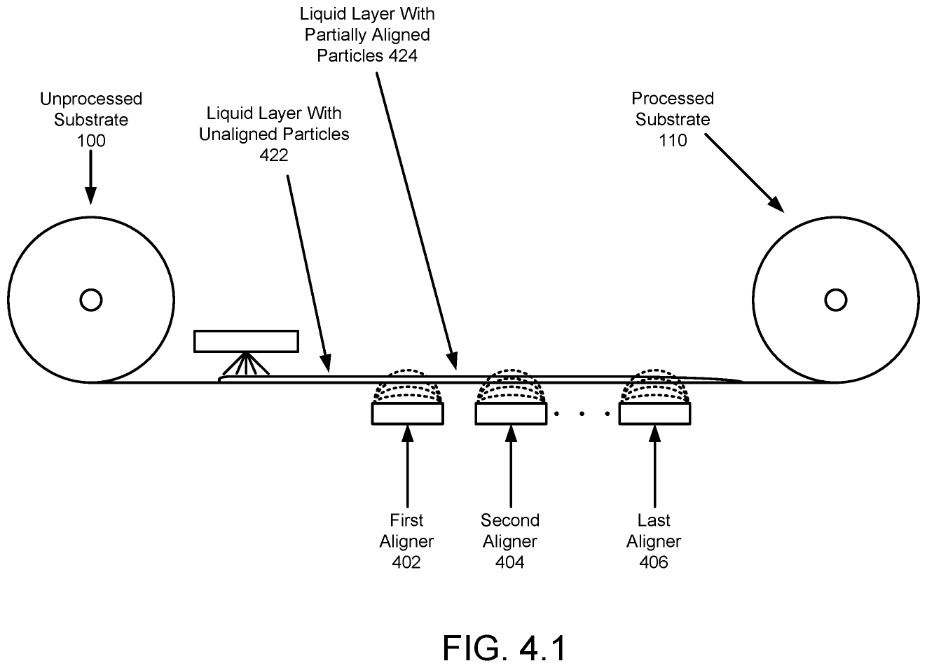

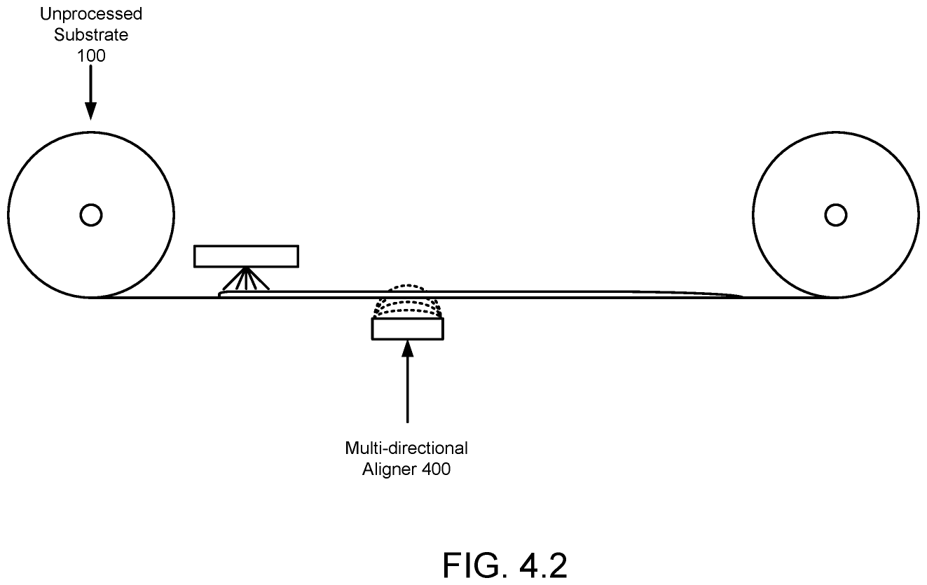

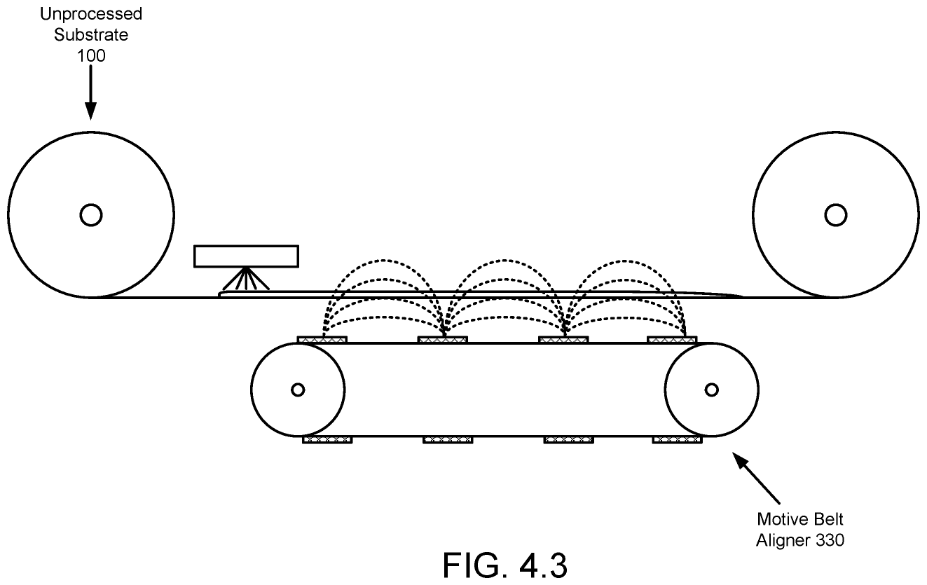

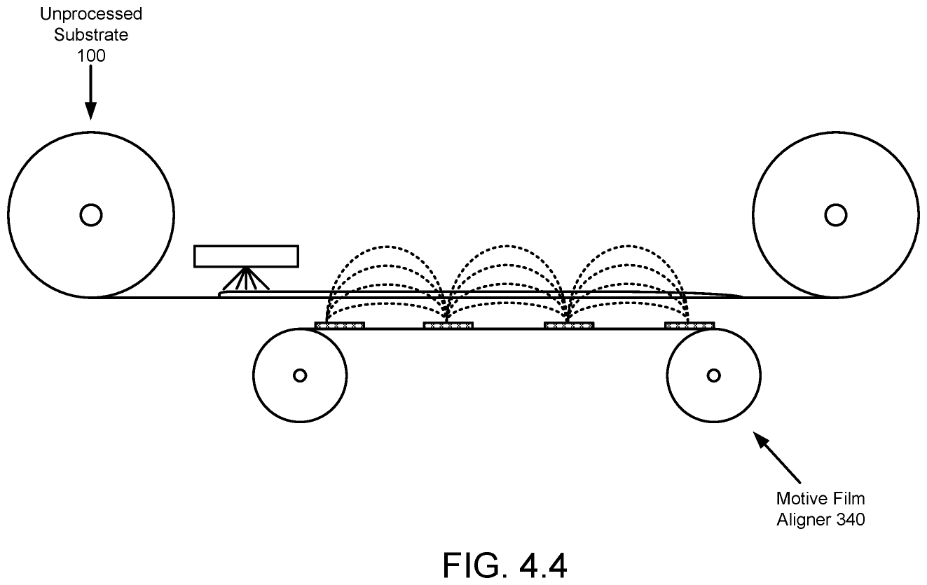

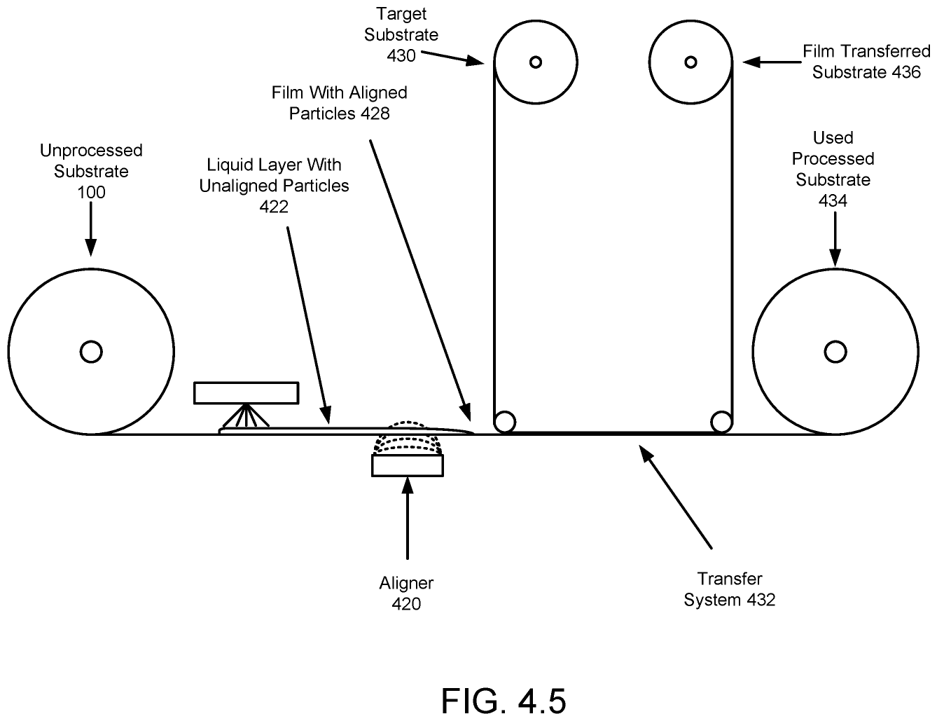

To further clarify aspects of processing unprocessed substrates, examples of substrate processing systems in accordance with one or more embodiments of the invention are illustrated in FIGS. 4.1-4.5. While described separately, one of ordinary skill in the art will understand that any of the features the aforementioned systems may be combined with any of the features of the other systems described in this application. Further, multiple similar systems may be combined together to form systems that repeatedly apply liquid layers and align the particles in the liquid layers to form films on substrates.

Turning to FIG. 4.1, FIG. 4.1 shows a diagram of a first example substrate processing system in accordance with one or more embodiments of the invention. The system of FIG. 4.1 may process unprocessed substrates (100) to obtain processed substrates (110).

The system of FIG. 4.1 may include multiple aligners (402, 404, 406). Each of the aligners may apply different electric fields to a liquid layer with unaligned particles (422). After the first aligner (402) applies electric field pattern to the liquid layer, a portion of the particles disposed in the liquid layer may align with the applied electric field pattern thereby forming liquid layer with partially aligned particles (424).

Liquid layer with partially aligned particles (424) may then be subjected to an electric field pattern generated by the second aligner (404). The electric field pattern applied by the second aligner (404) may cause a second portion of the particles of the liquid layer to align with the applied electric field pattern of the second aligner (404).

The aforementioned process may be repeated for any number of aligners until the last aligner (406) applies its electric field pattern to the liquid layer thereby resulting in the last portion of particles to be aligned with the field pattern of the last aligner (406).

By sequentially applying different electric field patterns using the aligners (402, 404, 406), a superstructure that includes particles aligned in multiple directions may be included in the process substrate (110). Consequently, anisotropic properties may be imparted the process substrate (110) having different levels of anisotropic tailored to meet desired specifications.

Turning to FIG. 4.2, FIG. 4.2 shows a diagram of a second example substrate processing system in accordance with one or more embodiments of the invention. The system of FIG. 4.2 may process unprocessed substrates (100) to obtain processed substrates (110).

Unlike the system of FIG. 4.1 that utilizes multiple aligners, the system of FIG. 4.2 may utilize a multidirectional aligner (400). The multidirectional aligner (400) may be used to apply electric fields to the same portion of the unprocessed substrate (100) thereby generating superstructure similar to that produced by the system of FIG. 4.1.

For example, different electrodes within the multidirectional aligner (400) may be separately or simultaneously charged to generate separate and/or superimposed electric field patterns. The aforementioned field patterns may be applied to the particles disposed in the liquid layer thereby forming a superstructure corresponding to the electric field patterns applied to the particles by the multidirectional aligner (400).

Turning to FIG. 4.3, FIG. 4.3 shows a diagram of a third example substrate processing system in accordance with one or more embodiments of the invention. The system of FIG. 4.3 may process unprocessed substrates (100) to obtain processed substrates (110).

Unlike the systems of FIGS. 4.1-4.2 that utilize static aligner, the system of FIG. 4.3 may utilize a motive belt aligner (330). The motive belt aligner (330) may generate an applied electric field that moves in a direction of travel of the unprocessed substrate (100). The rate of travel of the applied electric field may be matched to that of the unprocessed substrate (100).

For example, as the unprocessed substrate (100) is unrolled and fed into the substrate processing system, the unprocessed substrate (100) may move at 10 mm/s from left to right within the diagram of FIG. 4.3. In such a scenario, the drums of the motive belt aligner (330) may rotate clockwise at a rate that causes the electrodes to move at 10 mm/s. Consequently, the rate of movement of the unprocessed substrate (100) may be matched to that of the rate of movement of the electrodes of the motive belt aligner (330). Thus, the applied electric field generated by the motive belt aligner (330) may move with the liquid layer deposited on the unprocessed substrate (100). Accordingly, a consistent electric field may be applied to the liquid layer as the liquid layer traverses the substrate processing system.

Turning to FIG. 4.4, FIG. 4.4 shows a diagram of a fourth example substrate processing system in accordance with one or more embodiments of the invention. The system of FIG. 4.4 may process unprocessed substrates (100) to obtain processed substrates (110).

Like the system of FIG. 4.3 that utilize a motive aligner, the system of FIG. 4.4 may utilize a motive film aligner (340). The motive film aligner (340) may generate an applied electric field that moves in a direction of travel of the unprocessed substrate (100). The rate of travel of the applied electric field may be matched to that of the unprocessed substrate (100).

For example, as the unprocessed substrate (100) is unrolled and fed into the substrate processing system, the unprocessed substrate (100) may move at 10 mm/s from left to right within the diagram of FIG. 4.4. In such a scenario, the drums of the motive film aligner (340) may unroll and roll the film of the motive film aligner (340) at a rate that causes the electrodes of the motive film aligner to move at 10 mm/s from left to right in the diagram of FIG. 4.4. Consequently, the rate of movement of the unprocessed substrate (100) may be matched to that of the rate of movement of the electrodes of the motive film aligner (340). Thus, the applied electric field generated by the motive film aligner (340) may move with the liquid layer deposited on the unprocessed substrate (100). Accordingly, a consistent electric field may be applied to the liquid layer as the liquid layer traverses the substrate processing system.

Turning to FIG. 4.5, FIG. 4.5 shows a diagram of a fifth example substrate processing system in accordance with one or more embodiments of the invention. The system of FIG. 4.5 may process unprocessed substrates (100) to obtain a film with aligned particles (428) disposed on the substrate. The film may then be transferred to a target substrate (430) to obtain a film transferred substrate (436).

Like the system of FIG. 4.1, the system of FIG. 4.5 may utilize an aligner (420) to align particles in a liquid layer with unaligned particles (422) to obtain a film with aligned particles (428). However, the unprocessed substrate (100) may have properties that enable the film with aligned particles (428) to be transferred to another substrate. For example, the unprocessed substrate (100) may be formed from a low surface energy material (e.g., polydimethyl sulfoxide (PDMS)) that causes the film with aligned particles (428) to preferentially adhere to other substrates.

To transfer the film to a target substrate (430), a target substrate (430) may be unrolled and fed to a transfer system (432). The transfer system (432) may press the target substrate (430) against the film with aligned particles (428) thereby causing the film to transfer from the now-processed substrate to the target substrate (430). Accordingly, a film transferred substrate (436) having the film with aligned particles (428) disposed on it is obtained.

The transfer system may include any number and type of devices that cause the target substrate (430) to be pressed against the processed substrate to transfer the film (e.g., 428) from the processed substrate to the target substrate (430). For example, the target substrate (430) may be unrolled and pressed against the processed substrate using roller drums.

Thus, the result of the substrate processing system of FIG. 4.5 may be a film transferred substrate (436) and used processed substrate (434). The used processed substrate (434) may be reused as unprocessed substrate (100).

While the substrate processing systems of FIGS. 4.1-4.5 have been illustrated as including a limited number of components, a substrate processing system in accordance with embodiments of the invention may include additional, different, and/or fewer components without departing from the invention.

For example, a substrate processing system may include a substrate tensioning system. The substrate tensioning system may stretch substrate along one or more directions while it is being processed (e.g., deposition of a film having a superstructure). For example, tension may be placed along a direction of travel of the substrate thereby placing the substrate into a stretched state. After the substrate is processed, the tension on the substrate may be released thereby causing the substrate to contract along one or more directions of tensioning thereby placing the substrate into an unstretched state. The resulting contraction may cause the film deposited on the substrate to change shape (e.g., compress). The shape change of the film may cause changes in the morphology of the superstructures included in the films such as, for example, enhanced connectivity between particles of the films, increased pressure between particles in the films, etc.

In another example, a substrate processing system may include a blade (e.g., a mechanical aligner that uses physical contact to align/chain particles) or other method for aligning and/or chaining particles. For example, after a liquid layer is applied, a blade, squeegee, or other mechanical device may be employed to align some particles within the liquid layer in a first direction. A liquid layer then may be used to align a portion of the particles in a second direction (e.g., perpendicularly to the already aligned particles). Thus, multiple methods of aligning particles may be utilized to form superstructures.

In still further example, rather than utilizing multiple aligners or a multilayer aligner, a single aligner may be utilized to preferentially chain and align particles. For example, an aligner may be first be used chain and align particles in a first direction. The aligner may then be rotated to align it with a second direction. While in the second direction the aligner may be used to chain and align particles in the second direction. The aforementioned processed may be repeated as necessary to align different portions of particles with different directions.

Additionally, a substrate processing system may include addition processing steps such as, for example, substrate preparation (e.g., washing, surface treatment, etc.), film finishing (e.g., exposure to predetermined temperatures, inducement of chemical reactions, etc.), and/or device integration (e.g., formation of additional structures on top of and/or below the film generated by the substrate processing system).

Further, while described with respect to use as part of roll to roll manufacturing, one of ordinary skill in the art will appreciate that the manufacturing modalities disclosed herein may be adapted for other manufacturing purposes. For example, the aforementioned processes may be used with respect to sheet style substrates (e.g., sheets of glass) rather than flexible, rollable substrates. In such a system, a different motion control system (e.g., other than drums to unroll/roll/direct substrates) may be used to move substrates with respect to substrate processing systems.

Any of the components of the systems illustrated in FIGS. 1-4.5 may be automated as part of a manufacturing process. FIG. 5 shows a block diagram of a manufacturing system in accordance with one or more embodiments of the invention. The manufacturing system may be computer automated to enable the various portions of the manufacturing process to be performed in accordance with machine control.

The automated substrate processing system (500) of FIG. 5 may include an orchestrator (502), a liquid layer depositor (122), a liquid layer processor (124), and/or other components. Each of these components is discussed below.

The orchestrator (502) may orchestrate the operation of one or more components of the system of FIG. 5. For example, the orchestrator (502) may operate the liquid layer depositor (122) and/or the liquid layer processor (124) to obtain processed substrates and/or other desirable structures.

The orchestrator (502) may control the operation of the liquid layer depositor (122) and/or the liquid layer processor (124) using any method without departing from the invention. For example, if the liquid layer depositor (122) and liquid layer processor (124) are implemented as analog devices that respond to applied voltages, the orchestrator (502) may generate and apply appropriate voltages to the liquid layer depositor (122) to cause it to deposit desired liquid layers. Similarly, the orchestrator (502) may generate and apply appropriate voltages to the liquid layer processor (124) to apply electric fields to the liquid layers deposited by the liquid layer depositor (122) to obtain desired superstructures within the liquid layer.

In another example, if the liquid layer depositor (122) and the liquid layer processor (124) are implemented as computer implemented devices, the orchestrator (502) may send messages that include instructions to be performed by the aforementioned devices.

The orchestrator (502) may also obtain information from any number of sensors (not shown) to monitor substrate processing performed by the liquid layer depositor (122) and/or the liquid layer processor (124). For example, the orchestrator (502) may utilize cameras to observe the process of liquid layer deposition by the liquid layer depositor (122) to verify that an appropriate liquid layer is being generated by the liquid layer depositor (122).

The orchestrator (502) may be implemented using computing devices. The computing devices may be, for example, mobile phones, tablet computers, laptop computers, desktop computers, servers, or cloud resources. The computing devices may include one or more processors, memory (e.g., random access memory), and persistent storage (e.g., disk drives, solid state drives, etc.). The persistent storage may store computer instructions, e.g., computer code, that (when executed by the processor(s) of the computing device) cause the computing device to perform the functions described in this application and/or all, or a portion, of the methods illustrated in FIGS. 6.1-6.3. The orchestrator (502) may be implemented using other types of computing devices without departing from the invention. For additional details regarding computing devices, refer to FIG. 7.

The orchestrator (502) may be implemented using logical devices without departing from the invention. For example, the orchestrator (502) may be implemented using virtual machines that utilize computing resources of any number of physical computing devices to provide the functionality of the orchestrator (502). The orchestrator (502) may be implemented using other types of logical devices without departing from the invention.

While illustrated as including a limited number of specific components in FIG. 5, a substrate processing system in accordance with embodiments of the invention may include additional, fewer, and/or different components without departing from the invention.

FIGS. 6.1-6.3 show methods that may be performed to process a substrate.

FIG. 6.1 shows a flowchart of a method in accordance with one or more embodiments of the invention. The method depicted in FIG. 6.1 may be used to process a substrate in accordance with one or more embodiments of the invention. The method depicted in FIG. 6.1 may be performed by, for example, an orchestrator (e.g., 502, FIG. 5). Other components may perform all, or a portion, of the method of FIG. 6.1 without departing from the invention.

While FIG. 6.1 is illustrated as a series of steps, any of the steps may be omitted, performed in a different order, additional steps may be included, and/or any or all of the steps may be performed in a parallel and/or partially overlapping manner without departing from the invention. Additionally, any step in the method depicted in FIG. 2A may be performed any number of times without departing from the invention.

In step 600, liquid layer is deposited on a substrate. The liquid layer may be deposited on a substrate using a liquid layer depositor. For example, a liquid may be sprayed onto the substrate using the liquid layer depositor.

Liquid layer may be deposited onto the substrate using other methods without departing from the invention. For example, a substrate that already has a liquid layer deposited on the substrate may be obtained rather than depositing the liquid layer on the substrate.

In step 602, the liquid layer on the substrate is processed to obtain a film disposed on the substrate is a processed substrate.

In one or more embodiments of the invention, the liquid layer is processed by sending a message to a liquid layer processor. The message may specify that the electric field is to be applied to the liquid layer. In response to the message, the liquid layer processor may apply electric field to the liquid layer.

In one or more embodiments of the invention, the liquid layer is processed by applying a voltage. Applying the voltage to the liquid layer processor may cause a liquid layer processor to apply an electric field. For example, applied voltage may charge electrodes of the liquid layer processor. In another example, applying the voltage may cause charge electrodes to be moved more closely the liquid layer.

The liquid layer on the substrate may be processed using the method illustrated in FIG. 6.2. Liquid layer may be processed using other methods without departing from the invention.

Processing the liquid layer on the substrate may cause particles disposed in the liquid layer to change their position and/or orientation with respect to one another. The aforementioned changes may cause the superstructure formed from the particles to be generated. The superstructure may be preferentially aligned with one or more dimensions of the liquid layer.

After the superstructures formed a liquid component of the liquid layer may be removed to obtain the film. Liquid component may be removed by, for example, evaporation of the liquid component. The evaporation may be caused by, for example, ambient conditions or applied conditions (e.g., application of heat, light, etc.).

In step 604, the processed substrate is collected.

The process substrate may be collected by rolling the process substrate into a roll. The processed substrate may be rolled into a roll by, for example, sending instructions to a motion control system that operates one or more drums upon which the processed substrate may be rolled. The instructions may be provided to the motion control system using any method without departing from the invention.

In some embodiments of the invention, the film may be removed from the processed substrate prior to collection. For example, the film may be transferred to other substrates prior to collection of the processed substrate.

The method may end following step 604.

Using the method illustrated in FIG. 6.1, unprocessed substrates may be processed to impart desirable properties to the processed substrates.

Turning to FIG. 6.2, FIG. 6.2 shows a flowchart of a method in accordance with one or more embodiments of the invention. The method depicted in FIG. 6.2 may be used to process liquid layers in accordance with one or more embodiments of the invention. The method depicted in FIG. 6.2 may be performed by, for example, an orchestrator (e.g., 502, FIG. 5). Other components may perform all, or a portion, of the method of FIG. 6.2 without departing from the invention.

While FIG. 6.2 is illustrated as a series of steps, any of the steps may be omitted, performed in a different order, additional steps may be included, and/or any or all of the steps may be performed in a parallel and/or partially overlapping manner without departing from the invention. Additionally, any step in the method depicted in FIG. 2A may be performed any number of times without departing from the invention.

In step 610, an electric field is applied to particles disposed in liquid layer to obtain an arrangement of the particles. The electric field may be applied using the method illustrated in FIG. 6.3. The electric field may be applied using other methods without departing from the invention.

The arrangement of the particles may be superstructure. The superstructure may have elements such as chains of particles that are aligned in one or more corresponding directions. Consequently, the superstructure may have anisotropic properties.

In step 612, a liquid portion of the liquid layer is removed to obtain the processed substrate. The liquid portion of the liquid layer may be removed using any method without departing from the invention.

Removing the liquid portion may cause the particles, binder, and/or other components of the liquid layer to consolidate into a solid film. The solid film may include the arrangement of the particles.

The method may end following step 612.

Using the method illustrated in FIG. 6.2, liquid layers may be processed to obtain processed substrates having desirable properties.

Turning to FIG. 6.3, FIG. 6.3 shows a flowchart of a method in accordance with one or more embodiments of the invention. The method depicted in FIG. 6.3 may be used to apply an electric field to a liquid layer in accordance with one or more embodiments of the invention. The method depicted in FIG. 6.3 may be performed by, for example, an orchestrator (e.g., 502, FIG. 5). Other components may perform all, or a portion, of the method of FIG. 6.3 without departing from the invention.

While FIG. 6.3 is illustrated as a series of steps, any of the steps may be omitted, performed in a different order, additional steps may be included, and/or any or all of the steps may be performed in a parallel and/or partially overlapping manner without departing from the invention. Additionally, any step in the method depicted in FIG. 2A may be performed any number of times without departing from the invention.

In step 620, a first electric field pattern is applied to the particles to align a first portion of the particles in a first direction.

In one or more embodiments of the invention, the first electric field pattern is applied to the particles by charging a first set of electrodes proximate to the liquid layer. By charging the first set of electrodes, the first electric field pattern may be generated.

In step 622, a second electric field pattern is applied to the particles to align a second portion of the particles in a second direction.

In one or more embodiments of the invention, the second electric field pattern is applied to the particles by charging a second set of electrodes proximate to the liquid layer. By charging the second set of electrodes, the first electric field pattern may be generated.

The second set of electrodes may have a different shape and/or orientation with respect to the first set of electrodes. Consequently, the different sets of electrodes may generate different electric field patterns that may be applied to the particles in the liquid layer (either separately or simultaneously).

The method may end following step 622.

Using the method illustrated in FIG. 6.3, superstructures may be formed that have desirable characteristics. For example, by applying different electric field patterns to the particles, different groups of particles may be preferentially chained and/or aligned with different directions.

As discussed above, embodiments of the invention may be implemented using computing devices. FIG. 7 shows a diagram of a computing device in accordance with one or more embodiments of the invention. The computing device (700) may include one or more computer processors (702), non-persistent storage (704) (e.g., volatile memory, such as random access memory (RAM), cache memory), persistent storage (706) (e.g., a hard disk, an optical drive such as a compact disk (CD) drive or digital versatile disk (DVD) drive, a flash memory, etc.), a communication interface (712) (e.g., Bluetooth interface, infrared interface, network interface, optical interface, etc.), input devices (710), output devices (708), and numerous other elements (not shown) and functionalities. Each of these components is described below.

In one embodiment of the invention, the computer processor(s) (702) may be an integrated circuit for processing instructions. For example, the computer processor(s) may be one or more cores or micro-cores of a processor. The computing device (700) may also include one or more input devices (710), such as a touchscreen, keyboard, mouse, microphone, touchpad, electronic pen, or any other type of input device. Further, the communication interface (712) may include an integrated circuit for connecting the computing device (700) to a network (not shown) (e.g., a local area network (LAN), a wide area network (WAN) such as the Internet, mobile network, or any other type of network) and/or to another device, such as another computing device.

In one embodiment of the invention, the computing device (700) may include one or more output devices (708), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (702), non-persistent storage (704), and persistent storage (706). Many different types of computing devices exist, and the aforementioned input and output device(s) may take other forms.

Embodiments of the invention may provide for films having anisotropic properties. For example, the films may have anisotropic conductivities. To obtain such films, a roll to roll manufacturing method may be employed. The manufacturing method may enable particles to be preferentially chained and aligned with predetermined directions thereby enabling films having tailored anisotropy to be obtained.

One or more embodiments of the invention may be implemented using instructions executed by one or more processors of the data management device. Further, such instructions may correspond to computer readable instructions that are stored on one or more non-transitory computer readable mediums.

While the invention has been described above with respect to a limited number of embodiments, those skilled in the art, having the benefit of this disclosure, will appreciate that other embodiments can be devised which do not depart from the scope of the invention as disclosed herein. Accordingly, the scope of the invention should be limited only by the attached claims.

What is claimed is:

1. A substrate processing system, comprising:
a liquid layer processor; and
an orchestrator adapted to:
after a liquid layer is deposited on a substrate:
process, using the liquid layer processor, the liquid layer to obtain a film having an anisotropic conductivity disposed on the substrate,
wherein the film comprises high aspect ratio conductive particles that provide the anisotropic conductivity.

2. The substrate processing system of claim 1, wherein the liquid layer processor comprises:
a first set of interdigitated electrodes adapted to:
generate an electric field oriented in a first direction; and
apply the electric field to the high aspect ratio conductive particles while the high aspect ratio conductive particles are suspended in a liquid component of the liquid layer.

3. The substrate processing system of claim 2, wherein the liquid layer processor further comprises:
a dryer adapted to remove the liquid component.

4. The substrate processing system of claim 3, wherein the liquid layer processor further comprises:
a second set of interdigitated electrodes adapted to:
generate a second electric field oriented in a second direction, different from the first direction; and
apply the second electric field to the high aspect ratio conductive particles while the high aspect ratio conductive particles are suspended in the liquid component of the liquid layer,
wherein the second set of interdigitated electrodes is stacked on top of the first set of interdigitated electrodes,
wherein the second set of interdigitated electrodes is disposed a distance away from the first set of interdigitated electrodes along a direction of travel of the substrate.

5. The substrate processing system of claim 2, wherein the first set of interdigitated electrodes are disposed on a belt adapted to match a rate of travel of the first set of interdigitated electrodes to a rate of travel of the substrate.

6. The substrate processing system of claim 5, wherein the belt has a length in a direction of travel that is smaller than a length of the substrate in the direction of travel.

7. The substrate processing system of claim 2, wherein the first set of interdigitated electrodes are disposed on a film adapted to match a rate of travel of the first set of interdigitated electrodes to a rate of travel of the substrate.

8. The substrate processing system of claim 7, wherein the film has a length in a direction of travel that is matched to a length of the substrate in the direction of travel.

9. The substrate processing system of claim 1, wherein the substrate is in a stretched state while the liquid layer is processed, wherein the orchestrator is further adapted to place the substrate in an unstretched state after the film is obtained.

10. The substrate processing system of claim 1, wherein the orchestrator is further adapted to transfer the film from the substrate to a second substrate after the film is obtained.

11. The substrate processing system of claim 1, wherein the orchestrator is further adapted to, using a mechanical aligner, align a portion of the high aspect ratio conductive particles, wherein a direction of alignment of the portion of the high aspect ratio conductive particles is different from a direction of alignment applied by the liquid layer processor to a second portion of the high aspect ratio conductive particles.

12. A method for processing a substrate, comprising:
after a liquid layer comprising high aspect ratio conductive particles suspended in the liquid layer is deposited on the substrate:
aligning a first portion of the high aspect ratio conductive particles in a first direction to obtain first aligned particles;
aligning a second portion of the high aspect ratio conductive particles in a second direction to obtain second aligned particles; and
obtaining a processed substrate using the first aligned particles and the second aligned particles.

13. The method of claim 12, wherein aligning the first portion of the high aspect ratio conductive particles comprises:
generating a first electric field oriented in the first direction; and
applying the first electric field to the high aspect ratio conductive particles.

14. The method of claim 13, wherein aligning the second portion of the high aspect ratio conductive particles comprises:
generating a second electric field oriented in the second direction; and
applying the second electric field to the high aspect ratio conductive particles.

15. The method of claim 14, wherein the first electric field is applied while the substrate is moving in a direction of travel.

16. The method of claim 15, wherein the second electric field is applied while the substrate is moving in the direction of travel.

17. A non-transitory computer readable medium comprising computer readable program code, which when executed by a computer processor enables the computer processor to perform a method for processing a substrate, the method comprising:
after a liquid layer comprising high aspect ratio conductive particles suspended in the liquid layer is deposited on the substrate:
aligning a first portion of the high aspect ratio conductive particles in a first direction to obtain first aligned particles;
aligning a second portion of the high aspect ratio conductive particles in a second direction to obtain second aligned particles; and
obtaining a processed substrate using the first aligned particles and the second aligned particles.

18. The non-transitory computer readable medium of claim 17, wherein aligning the first portion of the high aspect ratio conductive particles comprises:
generating a first electric field oriented in the first direction; and
applying the first electric field to the high aspect ratio conductive particles.

19. The non-transitory computer readable medium of claim 18, wherein aligning the second portion of the high aspect ratio conductive particles comprises:
generating a second electric field oriented in the second direction; and
applying the second electric field to the high aspect ratio conductive particles.

20. The non-transitory computer readable medium of claim 19, wherein the first electric field is applied while the substrate is moving in a direction of travel.
